(19) United States
(12) Patent Application Publication
(10) Pub. No.: US 2003/0033169 A1
(43) Pub. Date: Feb. 13, 2003

(54) Automated data entry system and method for generating medical records

(76) Inventor: Douglas K. Dew, Palm Coast, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/209,647

(22) Filed: Jul. 30, 2002

Related U.S. Application Data
(60) Provisional application No. 60/308,771, filed on Jul. 30, 2001.

(51) Int. Cl. G06F 17/60

(52) U.S. Cl. 705/3

(57) ABSTRACT

An apparatus and method for generating a patient's medical record. The apparatus comprises a data entry device and a plurality of clinical tree-like pathways that are traversed as data describing the patient's condition is entered, for example, by the physician during the course of a clinical examination. The physician is prompted as to the additional health information required to continue traversing the tree. Once an end “leaf” is reached, the medical record is generated based on the traversed path.

This patent application claims the benefit of U.S. Provisional Patent Application No. 60/308,771, filed on Jul. 30, 2001.

### FIELD OF THE INVENTION

The present invention is directed generally to data entry systems and more particularly to data entry systems for generating medical records.

### BACKGROUND OF THE INVENTION

The generation and management of patient medical records is a critical function for medical facilities, including physician offices, clinics, laboratories, hospitals, and out-patient treatment facilities. The records serve several different functions for the each party associated with the delivery of medical services to the patient. Most importantly, they include critical information required to provide appropriate health care for the patient, including a medical history, results and impressions of physician examinations, treatment plans, administered prescription and non-prescription drugs, laboratory test results, etc. The records also contain information required for the prompt and accurate billing of the patient, and for appropriate reimbursement of the medical service provider by the patient, or a third party, such as an insurance carrier or government agency. In particular, the records contain the treatment and procedure codes used by carriers to identify the services rendered and the treatment plan, so that appropriate payment can be made to the provider. The medical records are subject to periodic audit by government agencies to review a physician's credentials or a hospital's certification. The records can also provide useful evidence for the plaintiff and the defendant in medical malpractice actions.

For the individual physician, an important component of the medical record is the record created during the office visit. The office visit begins with the patient supplying a medical history to the physician. Typically, this is accomplished by having the patient complete a medical history form where boxes are checked and supplemented with free-form explanatory comments. The patient may be assisted in this process by a member of the physician's staff. Certain routine procedures are then conducted, for example the patient's height, weight and blood pressure are determined by a nurse and the results noted in the record. Next the physician conducts the examination, during which current symptoms, if any, are identified. As the examination proceeds, the physician arrives at an impression of the patient's condition, advises the patient concerning the procedure plan under which additional tests will be administered, and develops a treatment plan for the observed conditions.

After the examination is completed, the patient is dismissed by the nurse and given an office visit summary that includes a description of the type of examination conducted, a summary of the ordered procedures, and a schedule for follow-up visits. The patient gives the summary to a member of the office staff, who receives the payment from the patient and makes the necessary follow-up procedure and office visit appointments. The office staff then assigns the appropriate medical procedure codes to the services rendered and forwards the information to the insurance carrier for payment.

Immediately after the examination, the physician creates a record of the interactions with the patient during the visit. Conventionally, the physician uses a dictation recording device, either a hand-held or desk-mounted unit, that records the spoken dictation onto a magnetic recording tape. Alternatively, the physician can dictate into a telephone-like device connected to a remote transcription facility. The information dictated includes the symptoms presented by the patient, the nature and results of the office physical examination, the physician's impression and primary and secondary diagnosis, discussions with the patient about this condition, and the care plan including recommended additional tests or procedures and the proposed treatment. After completing the dictation, the tape is given to a medical transcriptionist for creating the written record. The written transcript is later reviewed by the physician or a member of the physician's staff. Although the transcriptionist is typically trained in medical terminology, mistakes are made that require correction. Finally, the transcribed document becomes a part of the patient's permanent record.

Although the creation of the patient's record has been described in conjunction with a doctor's office visit, the process of dictating and transcribing the physician's notes occurs any time there is an interaction between the physician and the patient. For example, after a surgical procedure, the physician dictates the details of the surgical procedure for inclusion in the written record. When the results of a medical procedure or test become available, a notation must be added to the file as to the medical significance of the reported results. Hospital stays also require a physician or para-professional to generate a detailed record of the stay and a discharge summary. Certain elements of these records represent instructions to the patient, and others are for payment and insurance purposes.

In summary, the patient's medical file includes information from many different sources and in may different formats. It would be advantageous to reduce the time spent creating these records by automating certain segments of the records creation process. Fro example, according to one known technique, during the dictation process the physician can select “canned” phrases from a prepared list and instruct the transcriptionest to insert the phrase, thus saving some dictation time. There are also known software programs that convert the spoken word directly into a written document, avoiding the transcription step. However, these programs must be trained to the individual users voice characteristics and sometimes fail to accurately convert to the correct word. Thus there use in the medical field, where absolute accuracy is required, is limited. There remains a need for a system and method for generating accurate and complete patient records with efficiency and dispatch.

### BRIEF SUMMARY OF THE INVENTION

The apparatus and method of the present invention generates a patient's medical record. Patient examination and procedure results are entered into a data entry device according to a plurality of clinical pathways represented in the form of a tree structure including a plurality of hierarchical branches interconnecting a plurality of nodes. Each node represents a component of the medical record or a decision point. The tree is traversed as the physician or medical professional enters information into the data entry device. According to one embodiment, the data is entered by touching icons on a touch screen display. A patient's medical record is thus generated in response to the tree nodes traversed during the data entry process. According to the prior art, such a medical record is created by the known and laborious dictation technique. Thus the present invention represents a dictation system, a patient record generating system, a billing coding system and treatment generating system.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures.

FIG. 1 is a block diagram of a medical records generating apparatus according to the teachings of the present invention;

FIG. 2 illustrates a flowchart of the steps associated with generating the medical record;

FIG. 3 illustrates clinical pathways for generating the medical record;

FIG. 4 is a pictorial representation of the data entry device of FIG. 1; and

FIG. 5 is an exemplary image on the display screen of the data entry device.

### DETAILED DESCRIPTION OF THE INVENTION

Before describing in detail the particular automated data entry system and method in accordance with the present invention, it should be observed that the present invention resides primarily in a novel combination of hardware and software elements. Accordingly, these elements have been represented by conventional elements in the drawings, showing only those specific details that are pertinent to the present invention, so as not to obscure the disclosure with structural details that will be readily apparent to those skilled in the art having the benefit of the description herein.

The present invention comprises a software program and related system hardware and method for generating Health Care Finance Administration-compliant patient medical records based on known pre-examination clinical pathway flow charts. According to the teachings of the present invention, the clinical pathways are implemented as a decision tree structure with multiple branches extending from tree nodes. During the office examination the software-driven clinical pathways are traversed by the physician's selection of an output branch at each tree node, where the selection is based on the condition presented by the patient. Eventually, the tree is traversed to an end node that sets forth an impression, diagnosis or procedure or that indicates the need for additional information. As follow-up tests results become available, they are entered into the tree structure so that a final diagnosis and care plan are identified.

The medical record available at the conclusion of the examination is generally more detailed than the conventional dictated record. Further, because it was generated in response to prompts from the software of the present invention, the record represents the results of an examination directed by a decision tree based on medically accepted clinical pathways. Use of the decision tree structure thus enhances the probability that a correct diagnosis will be achieved, while offering automatic “dictation” during the office examination. The record is accurately generated at the point of care and provides sufficient detail with marked reduction in transcription costs and physician dictation time. Advantageously, the system helps the physician better manage his/her time, reduces office paper work, reduces the time required to generate the proper medical records, and formulates a care plan that is available to the patient in printed form prior to leaving the office. The dictating and transcribing processes have been eliminated.

The mobile record generated according to the teachings of the present invention also includes ordered procedural tests, follow-up notes, informed consents, operative notes, procedure notes, referral request letters, consult response letters, and the ICD-9 and CPT procedure and diagnosis codes for use by the insurance carrier. The system provides compliant documentation for Medicare, Medicaid, utilization review, workman's compensation, managed care, insurance reimbursement, specialist referrals, and primary care physician review. All of these reports are generated at the time of the patient's visit by the system and method of the present invention. Since the record includes the applicable ICD-9 and CPT diagnosis and treatment codes for use by the insurance carrier and government agencies, the billing, utilization review and payment processes are simplified.

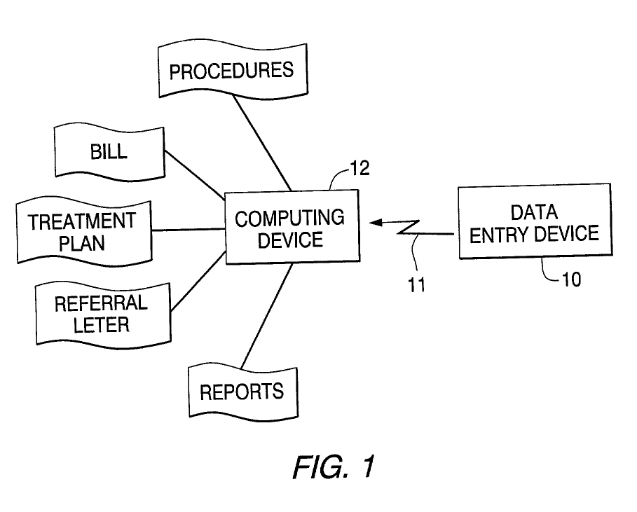

A system according to the present invention is illustrated in FIG. 1, including a data entry device 10 on which the software program embodying the present invention is resident. The data entry device 10 in one embodiment comprises a Compaq iPAQ, available from Hewlett Packard Corporation of Palo Alto, Calif. running a Windows CE® (a trademark of Microsoft Corporation) operating system. In particular, a Compaq iPAQ pocket personal computer Model 3670 with 64 Mb of memory is a suitable hardware platform.

The software program represents a clinical decision tree with nodes and interconnecting branches that executes within an application program, such as Microsoft Pocket Word. The branches of the decision tree are files named to have anatomical or clinical relevance. During the examination the physician selects the applicable file based on clinical findings and in this way progresses through the tree. In one embodiment, certain files contain text information that solicits additional information or provides instructions to the physician to assist in determining the output branch on the tree. Files can also contain visual images to assist the physician with the examination process.

The clinical decision tree terminates in an end file that is recorded in Microsoft Pocket Word or Microsoft Word. The end file is numbered and tagged for patient identification. The file stores all relevant information for that patient encounter, and thus forms the patient's chart or record. Since the preferred data entry device is a handheld computer, the patient's chart can be stored within the data entry device 10 and retained by the physician at all times. For example, when the physician visits the patient during hospital rounds, the patient's record is readily available on the data entry device 10.

The present invention also allows a physician to customize the final chart or record product by adding text information at the end. The clinical pathways can also be customized by the physician.

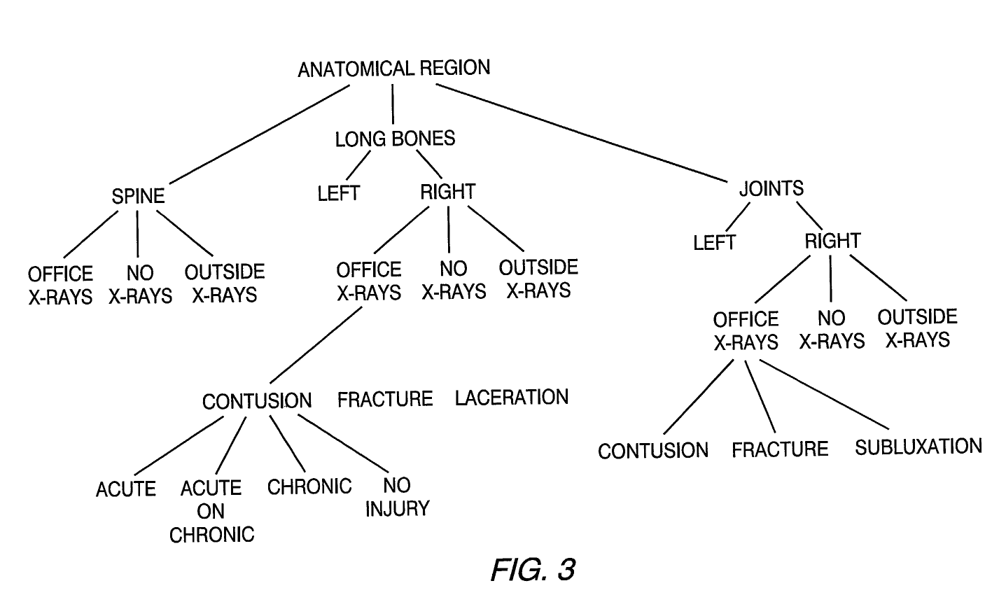

Advantageously, the program includes a clinical decision tree providing the physician with alternative tree paths at tree branches, with the selection of a tree branch based on examination results. Thus during the office examination the physician enters examination findings as they are made, and progresses through the tree structure toward a tree “leaf.” The end point leaf defines a diagnosis, suggests additional procedures and/or sets forth a treatment plan for the patient. In one embodiment, the leaf can include a summary of the examination process or an advertisement for a drug that can ameliorate the diagnosed condition. The software program will be discussed further in conjunction with FIG. 3 below.

The system of the present invention saves dictation costs not only for the physicians' office but also for ambulatory surgery centers, and hospitals. The system provides for automated generation of the patient's chart and updates thereto for initial in-patient consults, routine operative notes, routine hospital follow-up, and complete office examinations. The system can be used by any medical personnel to record the details of an interaction with a patient. Further, because the system is based on clinical pathways, it generates a care plan for the patient

In one embodiment, after the office examination results have been entered into the data entry device 10, as will be described further below, the information is communicated over a link 11 to a computing device 12 for storage and generation of the various reports and documents and scheduling of follow-up procedures and examinations. The data entry device 10 further can include an infrared port, a radio frequency transceiver or a wired port for communicating with the computing device 12. In one embodiment, the computing device 12 is an infrared-equipped printer for directly printing the medical record. Data entry and downloading are also available via the link 11 with a fully-configured desktop or laptop personal computer represented by the computing device 12. The patient record file stored in the data entry device 10 can be synchronized with the record stored in the computing device 12 using known file synchronization techniques. Back-up files can also be created from the fully configured computer. In one embodiment the data entry device 12 includes a flash memory slot for receiving additional memory to provide internal data backup capabilities

Several exemplary documents generated according to the teachings of the present invention are represented in FIG. 1. Additional indicated procedures, such as x-rays and blood work, are automatically ordered and scheduled. The patient's bill, treatment plan and informed consent forms are printed. Referral letters and reports to the primary care physician are assembled and printed from the computing device 12. Reports and billing information for the insurance carrier and government health care agencies and generated. The decision tree structure of the data entry process allows the automatic assignment of appropriate procedure and diagnosis codes as branches of the tree are encountered during the examination process.

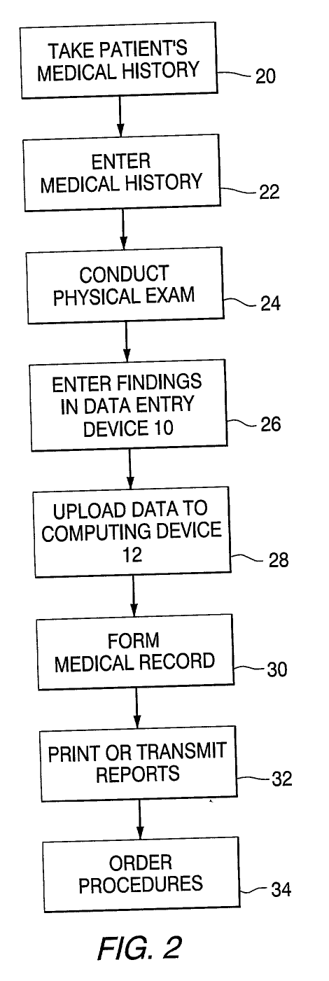

FIG. 2 is a flowchart illustrating the steps associated with a patient's visit to a physician's office. This is presented merely as an example of one application for the present invention, as the basic concepts of the invention can be employed by any medical service provider to generate the necessary medical record of services provided.

At a step 20 the details of the patient's present illness and past medical history are taken and recorded. Conventionally, this is accomplished by having the patient complete a preprinted form that includes, the patient's name, identification number, site (office or hospital), date of encounter, insurance information, primary care physician name, date of injury (if any), whether the injury is work related, medication list, past medical history, past surgical history, family history, social history, and review of any present symptoms. Ancillary office staff begin the creation of the electronic medical record by entering the demographic and medical history information from the medical history form into the computing device 12. See a step 22. For example, the electronic record may be in the form of a Microsoft Word document on the computing device 12. The document has an established format that the staff member populates with the information taken from the patient's medical history form. At this stage patient identification labels can also be pre-printed for later attachment to the various reports, letters, procedure results, etc. that are generated in conjunction with the medical services rendered.

At a step 24 the physician conducts a physical examination of the patient, with particular attention to any present symptoms. As indicated at a step 26, during the examination the physician enters examination findings into the data entry device 10. In another embodiment the physician enters the findings into the data entry device 10 after the examination has been completed. However, data entry during examination is preferable, as the decision tree structure of the data entry software running on the data entry device 10 assists the physician by identifying examination processes that the physician should conduct to accurately diagnosis any extant medical conditions. Alternatively, the findings can be entered by a para-professional during or following the examination under the direction of the examining physician.

Following the examination and the entry of the pertinent information into the data entry device 10, at a step 28 the data is uploaded from the data entry device 10 to the computing device 12, which in various embodiments can comprise a desktop or laptop computing device or a network server. This data transfer can be accomplished over a wireless link (for instance a radio frequency or optical communications link) directly from the data entry device 10, or by mating the data entry device 10 with a docking station that communicates over a wireless or wired link with the computing device 12. Those skilled in the art recognize that there are several available techniques for accomplishing this data transfer process. In lieu of or in addition to the data transfer to the computing device 12, the data can be transferred to a printer for creating a hardcopy record.

At a step 30, the downloaded examination and care plan information is joined to the preliminary medical record that was created at the step 22, forming a complete medical record that includes all relevant information collected to this point during the medical care delivery process. The medical record also includes the patient's care plan as determined from the traversed clinical pathway.

An office staff member operates the computing device 12, as indicated at a step 32, to print or transmit certain reports, derived from the medical record, for the patient before he/she departs the physician's office. For instance, the medical record includes the various predetermined codes that identify the nature and extent of the physician's examination. This information is used to generate the invoice, which will include the billing codes, for use by the physician's billing personnel to determine the applicable examination fee and the segregation of that fee into the patient's share and the insurance carrier's share, if there is applicable insurance coverage. Another segment of the medical record includes the patient's care plan, including physician-advised treatments (e.g., prescription drugs, exercises, patient limitations or constraints) and additional ordered procedures such as x-rays, blood work, etc.

In addition generating the various reports, if operative intervention is needed, a complete informed consent is provided, including a review of the possible complications, alternative treatments, advice on seeking a second opinion, infection rates, and expected outcomes based on the planned procedure. The nature of the consent required and the details of the operative intervention are determined based on the outcome from the decision tree clinical pathways.

For insurance correspondence, letters of authorization for operative procedures and diagnostic tests are automatically generated. Insurance correspondence, such as replies to denial letters, re-processing letters, medical necessity letters, assumption of care letters, and letters for reconsideration of unlisted codes can all be automatically generated when needed.

The process of extracting the relevant information from the medical records and generating the reports is simplified by the use of the aforementioned clinical pathways. For example, certain clinical pathways require a referral to a specialist and thus the computing device 12 generates the referral letter, including within it the relevant medical history and condition information available to date.

At a step 34 the computing device 12 orders the additional procedures suggested by the clinical pathway. For example, if an x-ray is required, the procedure is scheduled for the patient.

Exemplary partial clinical pathways for orthopedic surgeons are set forth in FIG. 3. The pathways can be represented as a hierarchical branching tree of files and subfiles within the data entry device 10. The physician traverses through the files by selecting the relevant subfile branching from the immediately previous subfile. Certain subfiles prompt the physician with a question to which he/she provides an answer (i.e., yes, no or equivocal) that determines the next subfile encountered in the tree. The tree can include Boolean logic operators for stringing together multiple findings to determine the next traversed branch. Differential diagnoses (i.e., equivocal findings) can also be incorporated into the tree. In this case, the tree can be traversed through multiple parallel paths until the equivocal finding is resolved and the correct diagnosis identified. The degree of severity of an examined condition can also be incorporated into the tree structure.

For orthopedic applications, the pathways are segregated into regional anatomical areas (for example, the spine, long bones, and joints). The next branch indicates the left or right side of the body, where applicable. The next step involves identifying the x-ray status and findings (no films taken, outside x-ray findings, or office x-ray findings).

For joints, the first subfile is divided into the possible joint conditions, including contusion, fracture, dislocation, subluxation, laceration, sprain, and no subluxation. For long bones, the subfile is divided into contusion, fracture, or laceration. The nature of the injury is then identified (acute injury, acute on chronic, chronic problem, no injury, or follow-up examination). The follow-up examination input includes improving, not improving, new symptom, resolved, or complication.

Thus as the tree is traversed, the clinical findings are entered as positive, negative, or equivocal through the selection of the appropriate subfile. The end result leads to a pre-formulated impression and care plan complete with diagnosis coding, procedure coding (such as injections, X-ray report, work status, recommended diagnostic tests, and/or referral plans). In addition, the medical report codes and documents the use of casting materials, medications, and other supplies.

It is known that insurance carriers exercise a degree of control over the medical care delivery process. In particular, certain procedures require carrier pre-approval prior to their administration. The carrier reviews the patient's medical record to determine whether to approve a procedure. According to the present invention, the insurance carrier can insert its approved clinical pathways into the software decision tree and thereby avoid the necessity of a pre-approval for a procedure that is on the pathway. For example, assume a given procedure requires pre-approval and the pre-approval is routinely granted only if certain conditions are presented. The insurance carrier and physician can avoid the pre-approval process by including the procedure in the decision tree only along the tree path that includes all of the conditions.

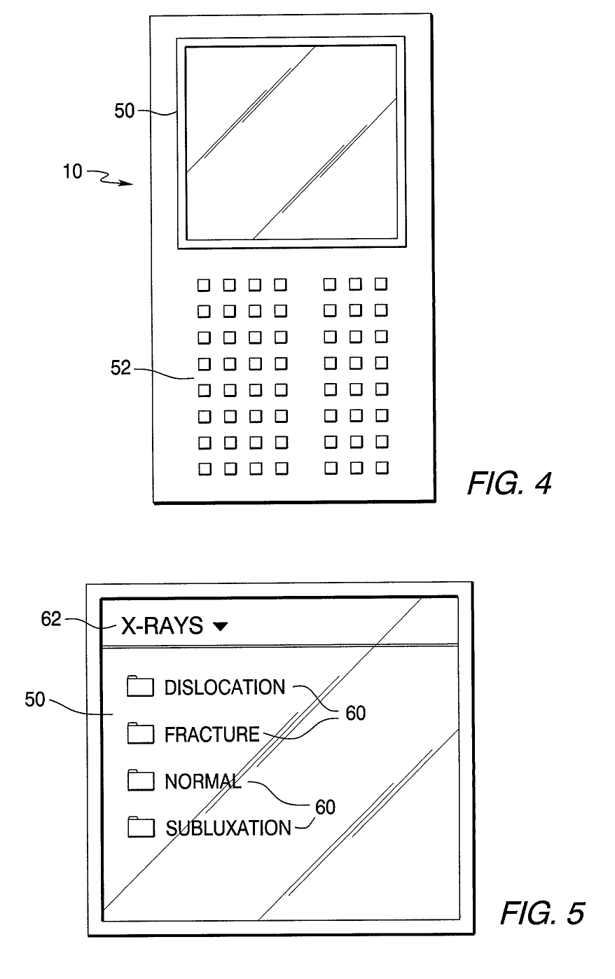

The data entry device 10 comprises a display 50 and a keypad 52 as shown in FIG. 4. Free text information can be entered into the data entry device 10 via the keypad at any step along a clinical pathway and referenced back to a previous entry if desired. The pathway branches are displayed as icons on the display 50 and in an embodiment where the display 50 includes touch screen capabilities, the path is selected by touching the icon that represents the desired path, such as the results of a clinical examination test.

FIG. 5 illustrates an exemplary image on the display 50, including a plurality subfiles 60 branching from a higher level subfile 62. In the embodiment where the screen 50 is a touch screen, the physician contacts the appropriate subfile 60, which then opens a plurality of additional subfiles branching from the opened subfile 60.

An apparatus and method have been described as useful for forming a patient's metal record. While specific applications and examples of the invention have been illustrated and discussed, the principals disclosed herein provide a basis for practicing the invention in a variety of ways and in a variety of circuit structures. Numerous variations are possible within the scope of the invention. The invention is limited only by the claims that follow.

What is claimed is:

1. An apparatus for receiving a patient's health information and for producing a medical record, comprising:
a data input module for receiving the patient's health information;
an analysis module comprising a plurality of clinical pathways in the form of a tree structure further comprising a plurality of hierarchical branches, wherein as an entry is made into said data input module the tree structure is traversed; and
an output module for generating the medical record in response to the tree path traversed during the data entry process.

2. The apparatus of claim 1 wherein the patient's health information is manually entered into the data input module.

3. The apparatus of claim 2 wherein the data input module comprises a keypad further comprising a plurality of keys, and wherein the patient's health information is entered by keystrokes applied to said plurality of keys.

4. The apparatus of claim 2 wherein the data input module comprises a touch-activated display screen, and wherein the patient's health information is entered by touching an appropriate area of said touch-activated display screen.

5. The apparatus of claim 1 wherein the patient's health information is automatically entered into the data input module.

6. The apparatus of claim 1 wherein the tree structure comprises a plurality of output branches extending from a node, and wherein the analysis module prompts for patient health information such that in response to the provided patient health information one of the plurality of output branches is selected.

7. The apparatus of claim 6 wherein the analysis module comprises a software program, and wherein each one of the plurality of branches is represented by a file in said software program.

8. The apparatus of claim 1 wherein the output module is resident in a computing device, and wherein the analysis module communicates with the output module in said computing device over a communications link.

9. The apparatus of claim 8 wherein the communications link is selected from a wireless link and a wired link.

10. The apparatus of claim 8 wherein the output module is a printer.

11. The apparatus of claim 1 wherein the medical record includes one or more of the patient's medical history, examination findings, procedure findings, scheduled procedures, impressions, diagnoses, treatment plan, diagnostic and procedure codes, and billing information.

12. The apparatus of claim 1 wherein the patient's health information includes a medical history.

13. The apparatus of claim 1 wherein the clinical pathways comprise insurance-carrier pre-approved procedures.

14. The apparatus of claim 1 wherein each one of the branches forms an element of the medical record, such that the path traversed through the tree structure is present in the medical record.

15. A method for producing a patient medical record, comprising:
entering the patient's health information in a data entry device, wherein each data entry generates a prompt for the next data entry, wherein the generated prompt is based on a plurality of clinical pathways in the form of a tree structure comprising a plurality of hierarchical branches; and
producing the medical record in response to the path traversed through the tree structure.

16. The method of claim 15 wherein the patient's health information is entered through a touch-activated display screen of the data entry device.

17. The method of claim 15 wherein the tree structure comprises a plurality of tree branches, and wherein one of the tree branches is selected as each item of the patient's health information is entered.

18. The method of claim 15 wherein the method comprises a software program, and wherein each one of the plurality of branches is represented by a file in said software program.

19. The method of claim 15 further comprising producing medical reports based on the medical record.

20. An article of manufacture comprising:
a computer usable medium having computer readable program code embodied therein for producing a patient's medical record, comprising;
computer readable program code configured to receive a patient's health information;
computer readable program code configured to form a plurality of clinical pathways in the form of a tree structure, wherein the tree structure is traversed in response to the received patient's health information; and
computer readable program code configured to generate the medical record in response to the tree path traversed.
